(19) United States
(12) Patent Application Publication
(10) Pub. No.: US 2009/0293649 A1
(43) Pub. Date: Dec. 3, 2009

(54) Leak-free check valve bailer with flow-controlling release nozzle

(76) Inventor: Larry Lijian Zhang, Cerritos, CA (US)

Correspondence Address: Larry Lijian Zhang, 14146 Firestone Blvd., Santa Fe Springs, CA, 90670, US

(21) Appl. No.: 12/154,643

(22) Filed: May 27, 2008

(51) Int. Cl. G01N 1/12

(52) U.S. Cl. 73/864.63

(57) ABSTRACT

The invention relates to a bailer that includes a leak-free, novel check valve assembly and a complemental flow-controlling release nozzle. The check valve is guided and confined to the valve housing and is configured with a contour rubber O-ring so that an airtight seal can be achieved when valve is closed. The release nozzle is designed to gradually open and close the check valve. Users thus are able to achieve desired sample outflows by turning the release nozzle just as using a faucet.

### BACKGROUND OF INVENTION

1. Field of the Invention

This invention relates to disposable bailers for environmental sampling use. More specifically, it relates to disposable bailers with a leak-free check valve and a thread-on flow-controlling release nozzle.

2. Description of the Prior Art

Bailers are elongate cylindrical tubes used to lower into bodies of liquid fluid to take fluid samples.

In present environmental sector, the most commonly used bailer features a free-floating ball valve at the lowermost end of the tube. When the bailer is lowered into a liquid body, the liquid fluid pushes open the ball valve and the liquid flows into the hollow interior of the bailer. When the bailer is lifted upwards the ball valve sinks back into its valve seating and seals the liquid inside the bailer.

The limitation of the ball valve design, however, is that the ball valve travels so easily away from its seating that it leaks when there is tilting or swinging as field technicians lift it up or carry it. Additionally, above-mentioned traditional bailer comes with a straw-shaped release tip that one has to stick hard into the lowermost end of the bailer to force open the ball valve. It is a tricky task because if pushed too hard it opens the ball valve suddenly to the maximum, resulting in a rushing outflow that will flood the container and workstation. Since there is undesired air contact to the sample, reliability of later analysis results can be affected. And it is even harder to retrieve such release nozzles to stop or pause the sample outflow.

As above stated there is a need for an improved bailer whose valve seals tight at all times and release nozzle regulates speed and volume of sample outflow.

### SUMMARY OF INVENTION

As a response to the need for a more reliable and user-friendlier bailer, the present invention overcomes the limitations of the prior art and provides a leak-free check valve at the lowermost end of the bailer and a threads-on release nozzle that regulates the outflow into sample containers.

The bailer is comprised of an elongated cylindrical hollow main body, a bottom end piece and a top end piece secured to the two ends of the main body, and a removable release nozzle.

The top end piece is a perforated cap with a handle ring. Perforation allows free fluid flow through the cylindrical main body of the bailer, while the handle ring comes in use when the liquid fluid body to sample is deep below ground surface and a rope or string should be attached to lower the bailer in.

The bottom end piece is a conical valve housing that features tapered sidewalls, which graduate into a cylindrical downspout with a diameter smaller than the main body. The exterior of the downspout is threaded for the convenience of attaching a release nozzle as well as an optional metal or plastic weight.

Sitting inside the conical valve housing is the check valve, which is comprised of a top piece and four legs. The top piece is of a dish shape with a diameter greater than the downspout, and slightly concaved towards the downspout for a seamless fit with the tapered sidewalls of the valve housing. A rubber O-ring is installed around the circumference of the dish top to ensure an airtight seal when the valve is closed. Four legs extend from the top piece into the downspout and with angled feet on the ends these four legs will claw to the inside rim seamed between tapered sidewalls and the cylindrical downspout when the check valve rises from its seating to a certain extent.

The check valve described above is made of materials with a particular density selected with respect to the density of the liquid to be sampled. Therefore the check valve opens at a predetermined depth below the surface of such liquid fluid body. When the liquid fluid pushes open the check valve, its four legs ensure the check valve admits sufficient inflow while stays in position near its housing, so that when the bailer is lifted up from the liquid body, the check valve closes immediately with minimal or no loss of sample, and stays tightly sealed even in moderate motion.

The removable release nozzle is configured to gradually open the check valve to achieve desired outflow. The nozzle is a single piece comprised of two concentric circular caps and a tube-shaped bottom outlet. The outside cap has knurled finger grip on its exterior, and threads on its interior to engage the downspout. The inside cap is taller than the outside cap in order to reach into the downspout and push open the check valve. As one further threads up the release nozzle, he can gradually open the check valve and achieve desired outflow speed and volume, from dripping to a running stream.

### BRIEF DESCRIPTION OF DRAWINGS

Please refer to the following description and drawings in accordance for a better understanding of the objects and designs of the invention:

FIG. 1 is a cross sectional view of an illustrative embodiment of the invention; and

FIG. 2 is a partial view of the check valve inside the bailer; and

FIG. 3 is a partial view of the lower end piece, i.e. the check valve housing; and

FIG. 4 is a partial view of the release nozzle.

### DESCRIPTION OF THE PREFERRED EMBODIMENT

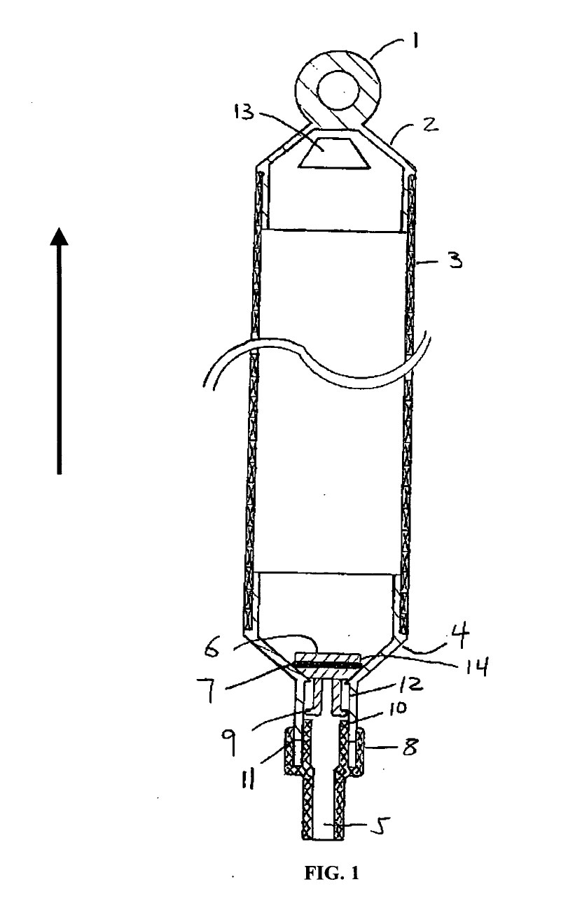

FIG. 1 depicts an exemplary embodiment of the invention.

The main body 3 is an elongated cylindrical tube with a hollow interior.

Element 2 is a top piece that is inserted and secured into the uppermost end of the main body 3 of the bailer. Perforation vent 13 ensures free fluid flow through the cylindrical hollow interior.

Top piece 2 has a handle ring 12 at its uppermost end to which can be secured a rope or string to lower the bailer into a body of liquid fluid.

Moving downward to the lowermost end of the main bailer sit the bottom piece 4, which is a conical-shaped valve housing snug-fitted and secured onto the main body 3. With tapered sidewalls, the check valve 6 closes and seals at the bottleneck between the sidewalls and the downspout 11, which has a significant smaller diameter than the main body 3.

The check valve 14 has a round, dish-shaped top 14 and four angled legs 9. The valve top 14 has a rubber O-ring 7 on its waist to ensure an airtight seal when the check valve closes. The four legs 9 serve to guide and confine the check valve as it rises and falls by clawing with their angled feet to the rim seamed between downspout 12 and the tapered sidewalls when the check valve top 6 rises to a certain extent. Check valve 6 rises and separates vertically from valve housing when liquid fluid flows into main body 3, stays open to allow maximum inflow when its legs 9 hit the bottleneck, and returns to its seating to close as soon as the bailer is retrieved from the sampled body. Screw threads are formed in the exterior of downspout 12 to engage optional weight or release nozzle when necessary. The release nozzle 8 is comprised of one bottom outlet 5 of a tubular shape and two concentric round caps, with inner cap 10 taller than outer cap 11. Outer cap 11 has threads in its interior sidewalls to engage downspout 12. Inner cap 10 pushes open the check valve 6 when the nozzle 8 is threaded onto downspout 12, and as nozzle 8 proceeds further sample outflow can be adjusted manually to meet different needs.

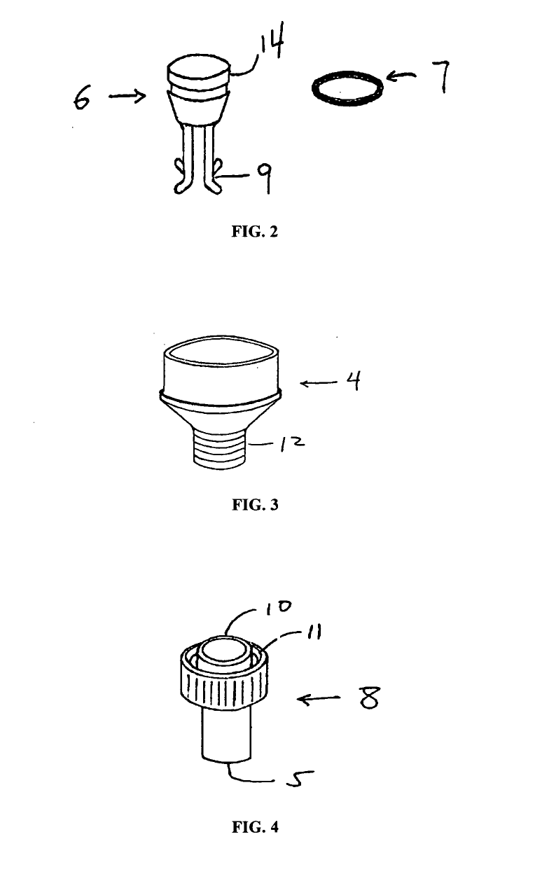

FIG. 2 depicts in detail the check valve 6 and its assembly. Round, dish-shaped valve top 14 features a slightly concaved top surface and a gland around its waist where the rubber O-ring 7 fits. And from below the O-ring gland the valve top is configured into a conical shape for a seamless seal against the tapered sidewalls of valve housing 4. Four valve legs 9 are each designed with feet with a right angle spreading outwards at the bottom end.

FIG. 3 depicts in detail the bottom piece 4, which is the check valve housing. From the top is a cylindrical piece with a slightly smaller diameter than the bailer main body, into which it is inserted and snug-fitted. Then the cylindrical piece graduates into a conical shaped valve housing with an externally threaded tubular downspout 12 at the bottom.

FIG. 4 depicts the release nozzle 8. As shown above the tubular bottom outlet 5, 10 and 11 are two concentric round caps, with inner cap 10 taller than outer cap 11. Outer cap 11 has threads in its interior sidewalls and knurl finger grips on the exterior. Compared to outer cap 11, inner cap 10 is thinner and taller in order to fit into the downspout 12 (shown in FIG. 3) and push open the check valve 6 (shown in FIG. 2).

Now that the invention has been described,

What is claimed is:

1. A bailer, comprising: an elongate hollow cylindrical body having a topmost and a lowermost end; a perforated top piece secured to said topmost end, said cap to be adapted to be engaged by a rope means to lower and lift of said bailer into and from a body of liquid fluid; said lowermost end having a check valve opening so that liquid fluid flows into said elongate cylindrical body when said bailer is immersed in a body of liquid fluid and said liquid fluid is substantially prevented from flowing out of said elongate cylindrical body when said bailer is retrieved from said body of liquid fluid.

2. The bailer of claim 1, wherein a valve housing with tapered sidewalls is formed on said lowermost end of said bailer and said check valve is formed of a complemental shape to inhibit undesired leakage. Said check valve adapted to be confined to said valve housing, minimizing chances of leakage resulted from tilting, swinging, or other movements of said bailer.

3. The bailer of claim 1, wherein said check valve has a rubber O-ring installed around the circumference of said check valve, minimizing leakage when said check valve is closed.

4. The bailer of claim 1, wherein external screw threads are formed in said lowermost end of said elongate cylindrical body and wherein screw threads are formed in said release nozzle so that said release nozzle can engage said lowermost end. Similarly an optional weight means can engage said lowermost end.

5. The bailer of claim 3, wherein said release nozzle is configured with an inner tubular valve opener to gradually push open said check valve when said release nozzle is threaded and to gradually close said check valve when said release nozzle is threaded off so that said liquid fluid can flow out in a controlled speed and volume.
